(19) United States
(12) Patent Application Publication
(10) Pub. No.: US 2020/0284296 A1
(43) Pub. Date: Sep. 10, 2020

(54) GEAR TRAIN OF AN ACTUATOR

(71) Applicant: DELPHI TECHNOLOGIES IP LIMITED, St. Michael (BB)

(72) Inventors: Francisco S. Gonzalez, Cd. Juarez, Chihuahua (MX); Samuel R. Palfenier, El Paso, TX (US); Benjamin Alejandro Ramirez Gonzalez, Cd. Juarez, Chihuahua (NX)

(21) Appl. No.: 16/295,438

(22) Filed: Mar. 7, 2019

(51) Int. Cl. F16C 19/30; F16H 57/02; F16H 63/24; F16C 33/34

(52) U.S. Cl. CPC F16C 19/30; F16H 57/02004; F16H 2057/0227; F16C 33/34; F16H 2057/02034; F16H 63/24

(57) ABSTRACT

A gear train includes a housing, a gear, a shaft, a needle bearing, and a stop shim. The housing includes an end face traversing an axis and a cylindrical surface centered to the axis. The face and the surface define a bore. The gear is disposed in the housing, and is adapted to rotate about the axis. The shaft is engaged to, and projects axially from, the gear. The shaft includes an end portion disposed in the bore. The needle bearing is seated in the bore, and is disposed radially between the surface and the end portion. The stop shim is disposed axially between the end face and the end portion for limiting axial displacement of the gear shaft. The stop shim is made of a material that is harder than a material of the housing.

### BACKGROUND OF THE INVENTION

The present disclosure relates to an actuator having a gear train, and more particularly, to a gear assembly of the gear train.

Motorized actuators utilized, for example, in the automotive industry have a wide range of applications, and may be applied to any mechanical device requiring a specific motion. For example, motorized actuators are utilized in EGR valves, throttle bodies, variable vane turbocharges, and other applications. Such actuators are often small with packaging and cost restraints, while needing to be robust and reliable in design. Unfortunately, known actuators use ball bearings to provide friction free rotation of internal gear shafts. Various load and vibration forces may wear upon such bearing and other components limiting the actuators useful life.

For example, known ball bearing assemblies used in such actuators have an outer periphery, or race, that is press fitted to an actuator housing, and an inner periphery, or race, of the ball bearing assembly is press fitted to the gear shaft. Consequently, axial movement of the shaft is limited by the ball bearing assembly, which must absorb axial forces. This axial absorption may reduce the useful life of the ball bearing assembly.

Accordingly, it is desirable to provide more robust actuator designs within packaging and cost restraints.

### SUMMARY OF THE INVENTION

According to one, non-limiting, exemplary embodiment of the present disclosure, a gear train includes a housing, a gear, a shaft, a needle bearing, and a stop shim. The housing includes an end face traversing an axis and a cylindrical surface centered to the axis. The face and the surface defines a bore. The gear is disposed in the housing, and is adapted to rotate about the axis. The shaft is engaged to, and projects axially from, the gear. The shaft includes an end portion disposed in the bore. The needle bearing is seated in the bore, and is disposed radially between the surface and the end portion. The stop shim is disposed axially between the end face and the end portion for limiting axial displacement of the gear shaft. The stop shim is made of a material that is harder than a material of the housing.

In accordance with another embodiment, a gear train includes a housing, a gear, a gear shaft, and a bearing assembly. The housing includes an end face traversing an axis and a cylindrical surface centered to the axis. The end face and the cylindrical surface define a bore. The gear is disposed in the housing, and is adapted to rotate about the axis. The gear shaft is engaged to, and projecting axially from, the gear. The gear shaft includes an end portion disposed in the bore. The bearing assembly includes a cylindrical bearing race seated in a bore, and a plurality of needle bearing elements disposed radially between the cylindrical bearing race and the end portion.

In accordance with another embodiment, a motorized actuator includes a housing, an intermediate gear assembly, and first and second play reduction assemblies. The intermediate gear assembly is mounted in the housing for rotation about an axis. The intermediate gear assembly includes a shaft, a driving gear, and a driven gear. The shaft has opposite first and second end portions. The driving gear is engaged to the shaft, and is axially disposed between the opposite first and second end portions. The driven gear is engaged to the shaft, and is axially disposed between the driving gear and one of the second end portion. The first and second play reduction assemblies are mounted to the respective first and second end portions, and are seated to the housing. The first and second play reduction assemblies each include a stop shim adapted to axially abut the first and second end portions, respectively, and a needle bearing adapted to rotationally support the shaft.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross section of an actuator utilizing a gear train as one exemplary embodiment of the present disclosure;

FIG. 2 is a disassembled perspective view of a gear assembly of the gear train; and

FIG. 3 is a perspective cross section of a second embodiment of a bearing assembly of the gear assembly.

### DETAILED DESCRIPTION

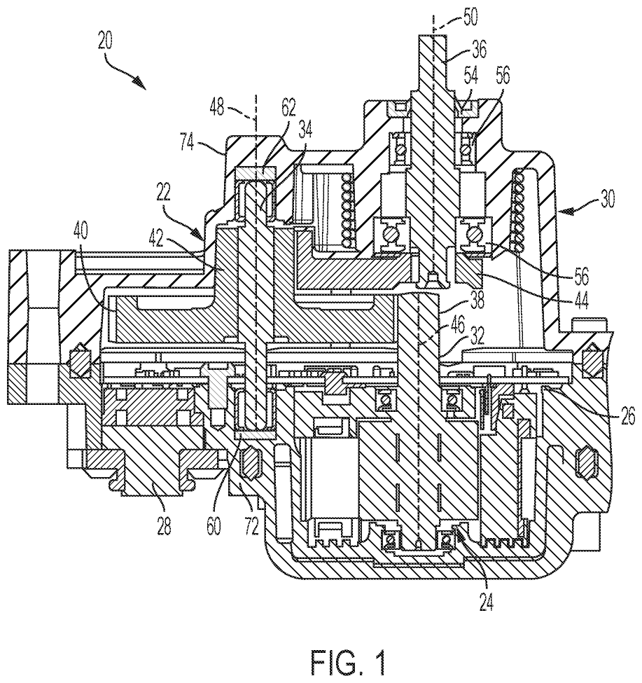

Referring now to the Figures, where the invention will be described with reference to specific embodiments, without limiting same, an actuator 20, which may be motorized, is illustrated in FIG. 1. Non-limiting applications of the actuator 20 may include actuation of automotive combustion engine throttle plates, actuation of variable vanes in a turbocharger, actuation of EGR valves, and others.

The actuator 20 may include a gear train 22, an electric motor 24, a controller 26 (e.g., electronic circuit board), an electrical connector 28, and a housing 30. The electrical connector 28 may facilitate the communication of control signals to the controller 26, and the routing of electric power to the controller 26 and the motor 24. In operation, the motor 24 is adapted to drive the gear train 22 within the housing, and the gear train drives the application (i.e., throttle plates, EGR valves, etc.).

In one embodiment, the gear train 22 includes an input shaft 32 (i.e., motor rotor), an intermediate shaft 34, an output shaft 36, an input gear 38, at least one intermediate gear (i.e., two illustrated as 40, 42), and an output gear 44. The input shaft 32 is adapted to rotate about a motor axis 46, the intermediate shaft 34 is adapted to rotate about an axis 48, and the output shaft 36 is adapted to rotate about an axis 50. The axes 46, 48, 50 are spaced from, and substantially parallel to, one-another. In other embodiments, additional gears may be part of the gear train 22 and mounted for rotation within the housing 30. Moreover, gear architecture may facilitate the axes 46, 48, 50 not being parallel to one-another in order to meet a packaging requirements and/or the needs of a specific application.

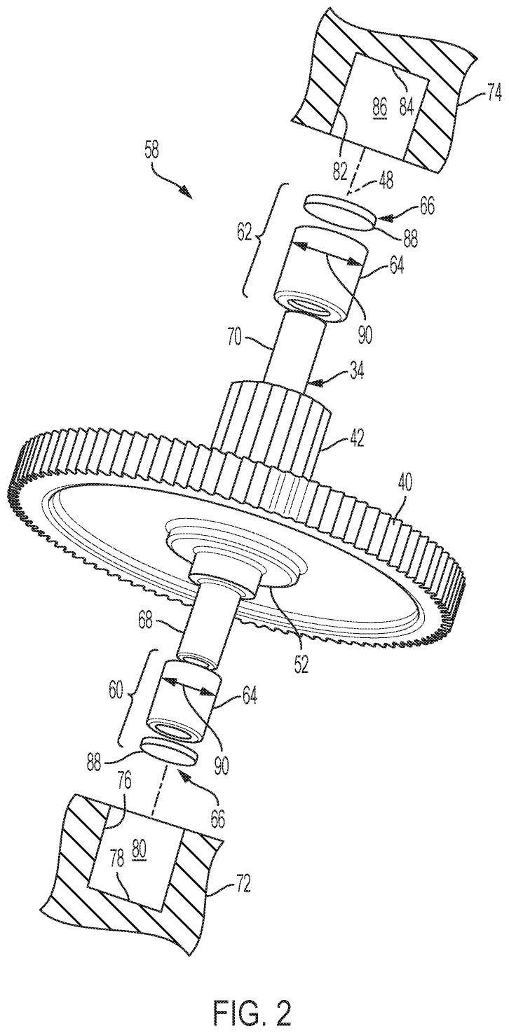

The gears 38, 40, 42, 44 may each include a plurality of gear teeth (not shown) for coupling with the teeth of adjacent gears as is known by one having skill in the art. Gear 38 is centered and fixed to an end portion of input shaft 32, gears 40, 42 are centered and fixed to a mid-portion 52 of intermediate shaft 34 (see FIG. 2), and output gear 44 is centered and fixed to output shaft 36 within the housing 30. In operation, gear 38 is coupled to and drives the gear 40 and gear 42 is coupled to and drives the output gear 44. In other embodiments additional gears (not shown) may be mounted between the gears shown to establish required torques, rotation speeds, packaging, and/or shaft orientations. It is contemplated and understood that the various gear to shaft engagements may be accomplished via a press fit, manufactured as a single piece, and/or other means.

In one embodiment, actuator 20 may further include a lip seal 54 seated to the housing 30, and adapted to seal about the rotating output shaft 36. Various bearings 56 may also be seated within, and to, the housing 30 for supporting and facilitating relatively friction free rotation of the output shaft 36.

Referring to FIGS. 1 and 2, the actuator 20 may include a gear assembly 58 housed by, and located within, the housing 30. In one example, gear assembly 58 includes the intermediate shaft 34, gears 40, 42, and at least one bearing assembly (i.e., two illustrated as 60, 62 in FIG. 2). Each bearing assembly 60, 62 includes a needle bearing 64 and a stop shim 66. The intermediate shaft 34 includes the mid-portion 52 and opposite end portions 68, 70. The mid-portion 52 extends axially between the end portions 68, 70 with respect to axis 48, with end portion 68 projecting axially outward from gear 40 and end portion 70 projecting axially outward from gear 42.

In one embodiment, the housing 30 includes two housing segments 72, 74 adapted to be fastened together during assembly. The first housing segment 72 includes a cylindrical surface 76 and an end face 78 that may be circular. The cylindrical surface 76 and the end face 78 define the boundaries of a blind bore 80 in the housing segment 72. The second housing segment 74 includes a cylindrical surface 82 and an end face 84 that may be circular. The cylindrical surface 82 and the end face 84 define the boundaries of a blind bore 86 in the housing segment 74.

When the actuator 20 is fully assembled, the end portions 68, 70 of the intermediate shaft 34 and the respective bearing assemblies 60, 62 are disposed in the respective blind bores 80, 86. More specifically, the needle bearings 64 of the bearing assemblies 60, 62 are seated against the respective cylindrical surfaces 76, 82, and the stop shims 66 of the bearing assemblies 60, 62 are placed against the respective end faces 78, 84. The intermediate shaft 34 is not constrained axially by needle bearings 64, and is thus capable of moving axially within the needle bearings.

In one embodiment, the stop shims 66 are disc-shaped each having a cylindrical side 88 that opposes, and is press fitted or close proximity to, the respective cylindrical surfaces 76, 82 carried by the respective housing segments 72, 74. The stop shims 66 are adapted to limit axial displacement of the intermediate shaft 34, and are made of a material that is harder than the material of the housing 30. For example, the stop shims 66 may be metallic while the housing may be made of a softer material (e.g., plastic). In another embodiment, the stop shims 66 may be made of steel and the housing 30 may be made of cast aluminum. To minimize friction, between the rotating intermediate shaft 34 and the stop shims 66, the shims may be coated with a friction reducing material such as graphite, Teflon, or others. In another embodiment, the stop shims may be a unitary part of the housing, or the housing may be made, at least partially, of a hardened material such that separate stop shims are not needed.

In one example, the axial displacement of the intermediate shaft 34 may be limited to a minimum displacement of greater than about 0.111 millimeters and a maximum axial displacement of about 0.289 millimeters (i.e., the maximum axial play). In one example, a diameter (see arrow 90 in FIG. 2) of the needle bearings 64 is within a range of about four (4) millimeters to eight (8) millimeters.

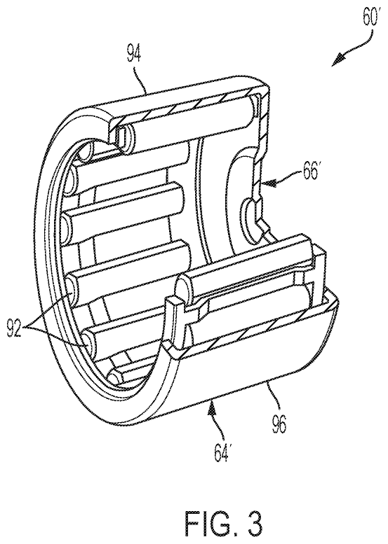

Referring to FIG. 3, a second embodiment of a bearing assembly is illustrated wherein like elements to the first embodiment have like identifying numerals except with the addition of a prime symbol suffix. A bearing assembly 60′ includes a plurality cylindrical elements 92 (i.e., needle bearings, or rolling elements) spaced circumferentially from one another and disposed in a housing 94. The housing 94 includes a bearing race 96 that may be substantially cylindrical, and a stop shim 66′. In one example, the bearing race 96 and the stop shim 66′ are one unitary piece that may be homogeneous. When assembled, the bearing race 96 seats against the cylindrical surface 76 of the housing segment 72, and the stop shim 66′ of the housing 94 axially bears upon (or intermittently bears upon) the end face 78 (also see FIG. 2).

Advantage and benefits of the present disclosure include an intermediate shaft whose axial displacement is not constrained by bearings, and is thus allowed to freely move axially for improved distribution of axial forces. Other advantages include an alternative to the use of ball bearings that may break during axial loading. Yet further, the present disclosure provide a relatively simple, robust, and optimized packaging design.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A gear train comprising:
a housing including a first end face traversing an axis and a first cylindrical surface centered to the axis, the first end face and the first cylindrical surface defining a first bore;
a first gear disposed in the housing and adapted to rotate about the axis;
a gear shaft engaged to and projecting axially from the first gear, the gear shaft including a first end portion disposed in the first bore;
a first needle bearing seated in the first bore and disposed radially between the first cylindrical surface and the first end portion; and
a first stop shim disposed axially between the first end face and the first end portion for limiting axial displacement of the gear shaft, wherein the first stop shim is made of a material that is harder than a material of the housing.

2. The gear train set forth in claim 1, wherein the material of the first stop shim is metallic.

3. The gear train set forth in claim 2, wherein the material of the housing includes a cast aluminum alloy and the material of the first stop shim includes steel.

4. The gear train set forth in claim 1, wherein the first stop shim is disc-shaped having a cylindrical side that opposes the first cylindrical surface.

5. The gear train set forth in claim 1, further comprising:
the housing including a second end face traversing the axis and a second cylindrical surface centered to the axis, the second end face and the second cylindrical surface defining a second bore;
the gear shaft extending through the first gear and including an opposite second end portion disposed in the second bore;
a second needle bearing seated in the second bore and disposed radially between the second cylindrical surface and the second end portion; and
a second stop shim disposed axially between the second end face and the second end portion for limiting axial displacement of the gear shaft, wherein the second stop shim is made of a material that is harder than the material of the housing.

6. The gear train set forth in claim 5, further comprising:
a second gear centered about the axis and engaged to the gear shaft.

7. The gear train set forth in claim 6, further comprising:
an output shaft rotatably seated in and projecting outward from the housing, wherein the output shaft is adapted to be rotationally driven by the first gear; and
an electric motor supported by the housing and adapted to rotationally drive the second gear.

8. The gear train set forth in claim 1, wherein the first needle bearing is four millimeter to eight millimeter in diameter.

9. A gear train comprising:
a housing including an end face traversing an axis and a cylindrical surface centered to the axis, the end face and the cylindrical surface defining a bore;
a gear disposed in the housing and adapted to rotate about the axis;
a gear shaft engaged to and projecting axially from the gear, the gear shaft including an end portion disposed in the bore; and
a bearing assembly including a cylindrical bearing race seated in a bore and a plurality of needle bearing elements disposed radially between the cylindrical bearing race and the end portion.

10. The gear train set forth in claim 9, wherein the bearing assembly includes a stop shim disposed axially between the end face and the end portion for limiting axial displacement of the gear shaft.

11. The gear train set forth in claim 10, wherein the bearing assembly includes a housing having the bearing race and the stop shim, and the housing is one unitary piece.

12. A motorized actuator comprising:
a housing;
an intermediate gear assembly mounted in the housing for rotation about an axis, the intermediate gear assembly including a shaft having opposite first and second end portions, a driving gear engaged to the shaft and axially disposed between the opposite first and second end portions, and a driven gear engaged to the shaft and axially disposed between the driving gear and one of the second end portion; and
first and second play reduction assemblies mounted to the respective first and second end portions and seated to the housing, the first and second play reduction assemblies each including a stop shim adapted to axially abut the first and second end portions respectively and a needle bearing adapted to rotationally support the shaft.

13. The motorized actuator set forth in claim 12, further comprising:
an output shaft rotationally mounted to the housing, projecting outward from the housing, and rotationally driven by the driving gear.

14. The motorized actuator set forth in claim 13, further comprising:
an electric motor supported by the housing and adapted to drive the driven gear.

15. The motorized actuator set forth in claim 14, wherein the motorized actuator is an automotive throttle plate actuator.

16. The motorized actuator set forth in claim 14, wherein the motorized actuator is an EGR valve actuator.

17. The motorized actuator set forth in claim 14, wherein the motored actuator is a turbocharger variable vane actuator.
